(19) United States
(12) Patent Application Publication
(10) Pub. No.: US 2023/0418667 A1
(43) Pub. Date: Dec. 28, 2023

(54) COMPUTING DEVICE FOR HANDLING TASKS IN A MULTI-CORE PROCESSOR, AND METHOD FOR OPERATING COMPUTING DEVICE

(71) Applicant: SAMSUNG ELECTRONICS CO., LTD., Suwon-si (KR)

(72) Inventors: Young Tae LEE, Suwon-si (KR); Soo Hyun KIM, Yongin-si (KR); Jong-Lae PARK, Anyang-si (KR); Choong Hoon PARK, Seoul (KR)

(73) Assignee: SAMSUNG ELECTRONICS CO., LTD., Suwon-si (KR)

(21) Appl. No.: 18/243,477

(22) Filed: Sep. 7, 2023

Related U.S. Application Data
(63) Continuation-in-part of application No. 16/444,632, filed on Jun. 18, 2019, now Pat. No. 11,789,773.

(30) Foreign Application Priority Data
Nov. 15, 2018 (KR) 10-2018-0140627

(51) Int. Cl. G06F 9/48; G06F 15/80

(52) U.S. Cl. CPC G06F 9/4881; G06F 15/80

(57) ABSTRACT

A computing device includes a multi-core processor which includes two or more cores, each having a significant task list queue and a normal task list queue, and a scheduler which allocates a task to each of the two or more cores. The scheduler, following allocation of the tasks, receives a new task, selects one core among the two or more cores based on task information of the new task, and allocates the new task to the selected core, when the allocation of the new task to the selected core will not change an execution schedule of a significant task in the significant task list queue of the selected core.

### CROSS-REFERENCE TO RELATED APPLICATION

This application is a Continuation-In-Part (CIP) of U.S. application Ser. No. 16/444,632, filed on Jun. 18, 2019, which claims priority from Korean Patent Application No. 10-2018-0140627, filed on Nov. 15, 2018, in the Korean Intellectual Property Office, the disclosures of each of which being incorporated by reference herein in their entireties.

### BACKGROUND

### 1. Field of the Disclosure

The present disclosure relates to a computing device and a method for operating the computing device.

### 2. Description of the Related Art

A multi-core processor includes a plurality of cores, and when tasks scheduled to be processed by the multi-core processor are generated, the scheduler allocates the tasks to be processed to the plurality of cores of the multi-core processor.

Among tasks, some tasks have a pattern that is repeated at a constant cycle, or a pattern repeated many times.

### SUMMARY

According to an aspect of one or more embodiments, there is provided a computing device comprising a multi-core processor which includes at least two cores, each having a significant task list queue and a normal task list queue; and a scheduler which allocates a task to each of the at least two cores. The scheduler is configured to, following allocation of the tasks, receive a new task, select one core among the at least two cores based on task information of the new task, and allocate the new task to the selected core, when the allocation of the new task to the selected core will not change an execution schedule of a significant task in the significant task list queue of the selected core.

According to an aspect of one or more embodiments, there is provided a computing device comprising a multi-core processor which includes a first core and a second core; and a task allocating and managing module configured to compare task information of a new task with an execution schedule of previous significant tasks and previous normal tasks that have been previously allocated to the first core, and allocate the new task to one of the first core and the second core, based on whether the new task will change an execution schedule of at least one of the previous significant tasks of the one of the first core and the second core.

According to an aspect of one or more embodiments, there is provided a method for operating a computing device, the method comprising receiving a new task by the computing device which includes a multi-core processor including a plurality of cores; classifying the new task into a user driven task and a normal task based on task information including task attributes and priority values of the new task; and allocating the new task to one core among the plurality of cores depending on a classifying result.

According to an aspect of one or more embodiment, there is provided a computing device, the computing device comprising a multi-core processor which includes a plurality of cores and a scheduler configured to receive a new task, select a first core of the plurality of cores, allocate the new task to the first core when task information of the new task indicates that allocating the new task to the first core will not change the execution schedule a task previously allocated to the first core, when the task information of the new task indicates that allocating the new task to the first core will change the execution schedule of the task previously allocated to the first core, select a second core of the plurality of cores other than the first core, and allocate the new task to the second core based on task information of the new task and an execution schedule of a task previously allocated to the second core.

However, aspects of the present disclosure are not restricted to the one set forth herein. The above and other aspects of the present disclosure will become more apparent to one of normal skill in the art to which the present disclosure pertains by referencing the detailed description of the present disclosure given below.

### BRIEF DESCRIPTION OF THE DRAWINGS

The above and other aspects and features of the present disclosure will become more apparent by describing in detail example embodiments thereof with reference to the attached drawings, in which:

FIG. 1 is a block diagram illustrating a computing device according to an embodiment of the present disclosure;

FIG. 2 is a block diagram illustrating a task classifying module of the computing device according to an embodiment of the present disclosure;

FIGS. 3 and 4 are block diagrams illustrating an expectable task managing module in a task allocating and managing module of the computing device according to an embodiment of the present disclosure;

FIGS. 5 and 6 are block diagrams illustrating a task allocating module in the task allocating and managing module of the computing device according to an embodiment of the present disclosure;

FIG. 7 is a block diagram for explaining a damage checking module in the task allocating and managing module of the computing device according to an embodiment of the present disclosure;

FIG. 8A and FIG. 8B are block diagrams illustrating a rebalancing module in the task allocating and managing module of the computing device according to an embodiment of the present disclosure;

FIG. 9 is a flowchart illustrating operation of the task classifying module of the computing device according to an embodiment of the present disclosure;

FIG. 10 is a flowchart illustrating operation of the task classifying module of the computing device according to an embodiment of the present disclosure;

FIG. 11 is a flowchart illustrating operation of the expectable task managing module in the task allocating and managing module of the computing device according to an embodiment of the present disclosure;

FIG. 12 is a flowchart illustrating operation of the task allocating module in the task allocating and managing module of the computing device according to the embodiment of the present disclosure;

FIG. 13 is a flowchart illustrating operation of the damage checking module in the task allocating and managing module of the computing device according to an embodiment of the present disclosure;

FIG. 14 is a flowchart illustrating operation of a rebalancing module in the task allocating and managing module of the computing device according to the embodiment of the present disclosure;

FIG. 15 is a block diagram illustrating the computing device according to an embodiment of the present disclosure;

FIG. 16 is a flow chart illustrating an operation of a task allocating and managing module of the computing device according to an embodiment of the present disclosure.

FIG. 17 is a block diagram illustrating a task which is executed by a computing device according to an embodiment of the present disclosure;

FIG. 18 is a block diagram for explaining an operation of the task classifying module according to the embodiment of FIG. 17;

FIG. 19 is a block diagram illustrating an operation of the task allocating and managing module according to the embodiment of FIG. 17;

FIG. 20 is a block diagram illustrating an operation of the task classifying module according to the embodiment of FIG. 17;

FIGS. 21 to 23 are block diagrams illustrating an operation of the task allocating and managing module according to the embodiment of FIG. 17;

FIGS. 24 and 25 are flow charts illustrating an operation of the task allocating and managing module of the computing device according to an embodiment of the present disclosure;

FIG. 26 is a block diagram illustrating a task executed by the computing device according to an embodiment of the present disclosure;

FIG. 27 is a block diagram for explaining an operation of the task classifying module according to the embodiment of FIG. 26;

FIG. 28 is a block diagram illustrating an operation of the task allocating and managing module according to the embodiment of FIG. 26;

FIG. 29 is a flow chart illustrating an operation of the task allocating and managing module of the computing device according to an embodiment of the present disclosure; and

FIG. 30 is a block diagram illustrating an operation of the task allocating and managing module according to the embodiment of FIG. 29.

### DETAILED DESCRIPTION

Among the tasks scheduled to be processed, for example, tasks such as tasks related to sound and tasks related to a screen update are tasks that are substantially periodically executed, and their execution patterns are relatively constant. For example, tasks related to screen update are executed at fixed time intervals, and operations to be processed each time the tasks are executed are not significantly different from each other. In this way, the tasks having a pattern repeated at a constant cycle, or a pattern repeated many times even if not having a constant cycle are tasks (hereinafter referred to as expectable tasks) for which a future execution start time, an execution time, or the like may be predicted on the basis of the current execution pattern.

In a multi-core processor, when such expectable tasks are handled by the same core as normal tasks, the expectable tasks may be preoccupied by normal tasks or their execution may be delayed. Therefore, in scheduling the tasks in the multi-core processors, it is advantageous to implement a scheme to distinguish and schedule expectable tasks and normal tasks.

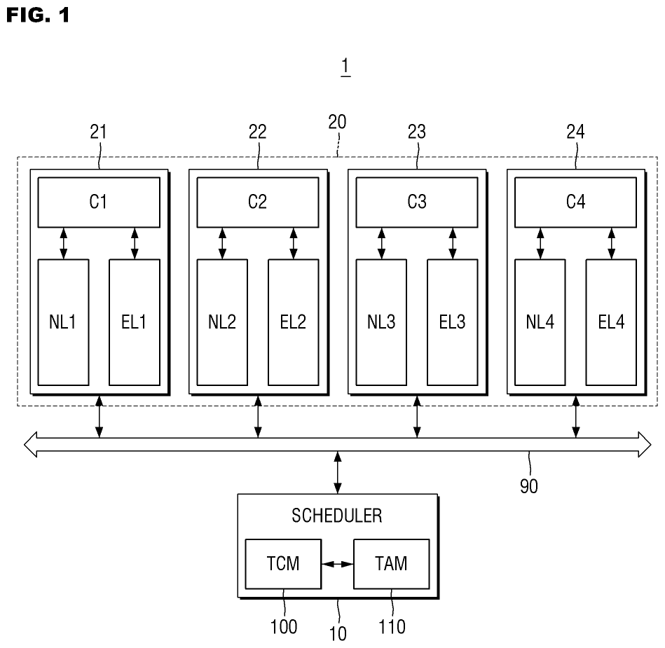

FIG. 1 is a block diagram illustrating a computing device according to an embodiment of the present disclosure.

Referring to FIG. 1, a computing device 1 according to an embodiment of the present disclosure includes a scheduler 10 and a multi-core processor 20, and a bus 90.

The scheduler 10 schedules one or more tasks to the multi-core processor 20. The scheduler 10 may be implemented as software by one or more microprocessors as a part of an operating system or a kernel which controls the computing device 1, and/or may be implemented as hardware such as an electronic circuit including a semiconductor element configured to perform the task scheduling.

The multi-core processor 20 includes a plurality of cores 21, 22, 23 and 24, each capable of executing a task allocated by the scheduler 10. The plurality of cores 21, 22, 23 and 24 may or may not be implemented to have the same performance as each other. For example, some cores of the plurality of cores 21, 22, 23 and 24 may be implemented to reduce power consumption and reduce performance, and some other cores may be implemented to have high power consumption and high performance.

The plurality of cores 21, 22, 23 and 24 may include expectable task list queues EL1, EL2, EL3 and EL4, respectively, and normal task list queues NL1, NL2, NL3 and NL4, respectively. An expectable task ET allocated by the scheduler 10 may be inserted into the expectable task list queues EL1, EL2, EL3 and EL4, and a normal task NT allocated by the scheduler 10 may be inserted into the normal task list queues NL1, NL2, NL3 and NL4.

Here, the expectable task ET denotes a task for which a future execution may be predicted on the basis of a current execution pattern. The expectable task may also be referred to as a patterned task, a process timing defined task, a significant task, or a user-driven task, according to various embodiments. For example, the expectable task ET may include a task repeatedly executed with a certain period, a task repeated many times even if not having a certain period, a task inevitably generated when a specific operating condition of the computing device 1 is satisfied, a task specified as an expectable task from the user, and the like. Representative examples of the expectable task ET may include tasks related to sounds and tasks related to updating screens. These tasks are substantially periodically executed tasks, and their execution patterns are relatively constant. However, the scope of the present disclosure is not limited thereto, and any task for which a future execution start time, an execution time, and the like may be predicted on the basis of the current execution pattern may correspond to the expectable task ET.

The plurality of cores 21, 22, 23 and 24 may execute the expectable task ET inserted into the expectable task list queues EL1, EL2, EL3 and EL4, and may execute a normal task NT inserted into the normal task list queues NL1, NL2, NL3 and NL4. In this specification, a case is illustrated in which a plurality of cores 21, 22, 23 and 24 includes the expectable task list queues EL1, EL2, EL3, EL4, respectively, and the normal task list queues NL1, NL2, NL3 and NL4, respectively, and regions C1, C2, C3 and C4 are dividedly illustrated to process the tasks inserted into the expectable task list queues EL1, EL2, EL3 and EL4 and the normal task list queues NL1, NL2, NL3 and NL4. In other words, strictly speaking, semiconductor circuits corresponding to the regions C1, C2, C3 and C4 process the tasks, but for convenience of explanation, the plurality of cores 21, 22, 23 and 24 are described as processing the tasks.

In this embodiment, the scheduler 10 includes a task classifying module (TCM) 100, and task allocating and managing module (TAM) 110.

The task classifying module 100 classifies the tasks to be processed by the multi-core processor 20 into an expectable task ET and a normal task NT.

The task allocating and managing module 110 selects one core of the multi-core processor 20 as a target core, and allocates the expectable task ET and the normal task NT to the target core. The target core selected here may be, for example, a core 22. Hereinafter, for convenience of explanation, it is assumed that the selected target core is the core 22, but it will be understood that the scope of the present disclosure is not limited thereto.

In the present embodiment, the task allocating and managing module 110 decides whether the normal task NT is allocated to the target core 22, depending on whether the target core 22 processes the expectable task ET.

For example, when the scheduler 10 allocates the normal task NT to the target core 22 in a situation in which the target core 22 processes the expectable task ET that should be processed periodically, there may be problems such as preoccupancy and delay. Specifically, when the processing priority of the normal task NT is higher than that of the expectable task ET already allocated to the target core 22, since the target core 22 disturbs processing of the expectable task ET and processes the normal task NT, problems such as preoccupancy and delay of the expectable task ET may occur. If the expectable task ET is a task of periodically updating the screen, such a problem may become a problem that affects the user by delaying the screen updating.

In addition, even if the expectable task ET is executed repeatedly, but when the load thereof is small, if the scheduler 10 decides that the load of the target core 22 is small to successively allocate the normal task NT to the target core 22, the above-mentioned problem repeatedly occurs.

In order to address such a problem, the scheduler 10 according to various embodiments of the present disclosure includes a task classifying module 100 and a task allocating and managing module 110, which will be described in detail below.

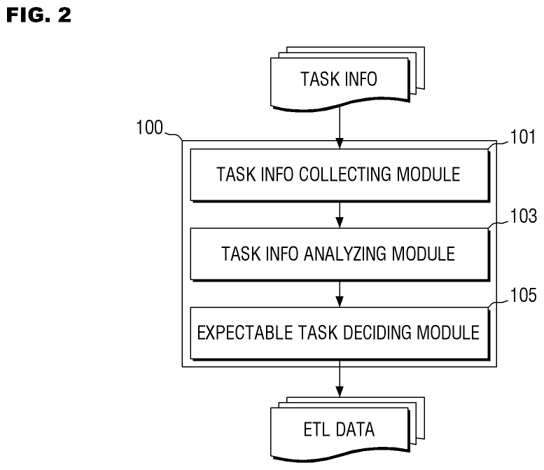

FIG. 2 is a block diagram illustrating the task classifying module of the computing device according to an embodiment of the present disclosure.

Referring to FIG. 2, the task classifying module 100 of the computing device 1 according to an embodiment of the present disclosure includes a task information collecting module 101, a task information analyzing module 103, and an expectable task deciding module 105.

The task information collecting module 101 collects information (TASK INFO) on the task scheduled to be processed. Here, the information (TASK INFO) on the task scheduled to be processed may include, for example, various kinds of information, such as task create information on an initial create operation of the task, task create time information, task enqueue information on the operation of allocating the task to a processor (or CPU (Central Processing Unit), core), task load update information on the operation of calculating the load of the task allocated to the processor (or CPU, core), task dequeue information on the operation of removing the allocated task from the processor (or CPU, core), task dead information on the termination and extinction operations of the task, and other user specified parameter information. However, embodiments are not limited thereto and, in some embodiments, the information may vary depending on the purpose of a use implementation.

The task information analyzing module 103 analyzes the information collected by the task information collecting module 101. That is, the task information analyzing module 103 may analyze the aforementioned information to generate information for predicting a future task execution pattern.

For example, the task information analyzing module 103 may analyze the collected information to derive the execution time prediction information and the next start time prediction information on the task scheduled to be processed. That is, when the task scheduled to be processed is executed in the future, it is possible to derive prediction information on, for example, how long the execution time will take, at which cycle the task will be repeatedly executed, and how many times the task will be executed repeatedly.

The expectable task deciding module 105 classifies the task scheduled to be processed into the expectable task ET and the normal task NT on the basis of the analysis result of the task information analyzing module 103.

For example, the expectable task deciding module 105 may classify the task scheduled to be processed into the expectable task ET and the normal task ET, on the basis of at least one of execution time prediction information and the next start time prediction information NT. That is, the task scheduled to be processed in which the execution time, the next start time, the number of times of repetition, and the like are decided to have an expectable execution pattern may be classified as the expectable task ET, and the task scheduled to be processed which is a one-time task or in which a particular execution pattern is not found may be classified as the normal task NT.

In the present embodiment, the expectable task deciding module 105 may output expectable task list data ETL, as a result of classifying the task scheduled to be processed into the expectable task ET and the normal task NT. The expectable task list data ETL may be used for an expectable task managing module 111 of a task allocating and managing module 110 to be described later to manage the expectable task ET. However, the scope of the present disclosure is not limited thereto, and the expectable task deciding module 105 may output the result of classifying the task scheduled to be processed into the expectable task ET and the normal task NT in any form which is recognizable by the expectable task managing module 111.

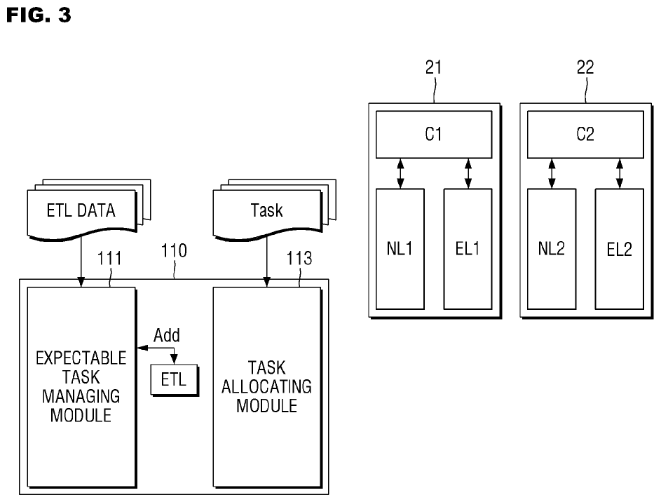

FIGS. 3 and 4 are block diagrams for explaining the expectable task managing module in the task allocating and managing module of the computing device according to an embodiment of the present disclosure.

Referring to FIGS. 3 and 4, the task allocating and managing module 110 of the computing device 1 according to an embodiment of the present disclosure includes an expectable task managing module 111.

The expectable task managing module 111 manages the expectable task ET and the normal task NT classified by the task classifying module 100. The expectable task managing module 111 adds or deletes, to/from the expectable task list ETL, whether the task is the expectable task ET or the normal task NT. The expectable task list ETL and the normal task list NTL may be a data structure of any type, such as a queue, a stack, a linked list, and a table, which may be implemented in the task allocating and managing module 110.

The expectable task list ETL stores a list of the expectable tasks ET classified by the task classifying module 100. As illustrated in FIG. 3, the task scheduled to be processed corresponding to the expectable task list ETL may be inserted into, for example, the expectable task list queue EL2 of the core 22, and as illustrated in FIG. 4, the core 22 may execute the expectable task ET inserted into the expectable task list queue EL2. As illustrated in FIG. 4, for example, the expectable task managing module 111 may delete from the expectable task list ETL, the task which is previously inserted the expectable task list ETL but is currently waked up and decided to be unexpectable. Even if the task is allocated in the expectable task list queue EL of some core, the expectable task managing module 111 may delete the task together from the expectable task list queue EL of the core.

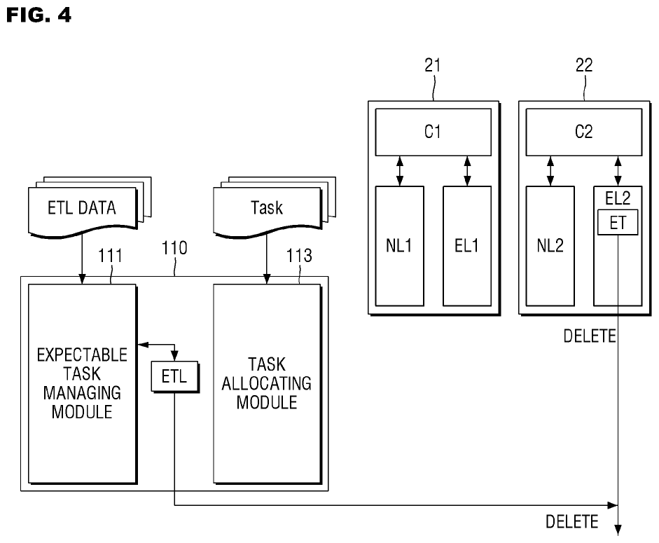

FIGS. 5 and 6 are block diagrams for explaining the task allocating module in the task allocating and managing module of the computing device according to an embodiment of the present disclosure.

Referring to FIG. 5, the task allocating and managing module 110 of the computing device 1 according to an embodiment of the present disclosure includes a task allocating module 113.

The task allocating module 113 allocates expectable tasks ET and normal tasks NT to the target cores 21 and 22, using the expectable task list ETL and the normal task list NTL. In particular, the task allocating module 113 may receive input of a new task (TASK) and allocate the new task to the target cores 21 and 22. For example, the new task is a newly inputted task to the task allocating module 113 or an wake-up task which is existed in the computing device.

The task allocating module 113 may designate a new task as a normal task NT as default. Thereafter, the task allocating module 113 may search for a core among the plurality of cores 21-24 to which a new task is to be allocated in the multi-core processor 20.

When the task allocating module 113 initially selects the target core 22 as the core to which a new task NT1 designated as the normal task NT is allocated, if the target core 22 is already processing an expectable task ET or the expectable tasks ET1 and ET2 are already inserted into the expectable task list queue EL2 of the target core 22 (as shown in FIG. 5), the task allocating module 113 allocates the normal task NT1 to another core 21 other than the target core 22 of the multi-core processor 20.

As a result, in a situation in which the target core 22 processes the expectable tasks ET1 and ET2 which should be processed periodically, since the normal task NT1 is not newly allocated to the target core 22 but rather is allocated to another core 21, it is possible to prevent problems such as preoccupancy and delay between the expectable tasks ET1 and ET2 and the normal task NT1 in advance. Furthermore, since the another core 21 processes the normal task NT1 in parallel with the expectable tasks ET1 and ET2 being processed by the target core 22, it is possible to improve the performance, while efficiently using the resources of the computing device 1.

Specifically, as a result of analyzing the task inserted into the expectable task list ETL, if an execution pattern is not included and it is decided that future prediction is not possible, the tasks previously classified as the expectable task ET may be newly classified into the normal task NT and may be moved to the normal task list NTL. Likewise, as a result of analyzing the task inserted in the normal task list NTL, if it is decided that the task inserted in the normal task list NTL has a future expectable execution pattern, the task previously classified as the normal task NT may be newly classified as the expectable task ET and may be moved to the expectable task list ETL.

In the present embodiment, a case is illustrated in FIG. 5 in which the expectable task managing module 111 newly classifies a task NT2 previously classified as the normal task NT into the expectable task and adds the task NT2 into the expectable task list ETL.

Next, referring to FIG. 6, an example of the result in which the expectable task ET and the normal task NT are distinguished and scheduled by the scheduler 10 according to various embodiments of the present disclosure is illustrated.

In the case of the cores 21 and 24 of the multi-core processor 20, expectable tasks ET and normal tasks NT are allocated to the expectable task list queues EL1 and EL4 and the normal task list queues NL1 and NL2. In the case of the core 22, expectable tasks ET are allocated only to the expectable task list queue EL2, and the normal task list queue NL2 is empty. In the case of the core 23, normal tasks NT are allocated only to the normal task list queue NL3, and the expectable task list queue EL3 is empty.

That is, for example, since the scheduler 20 mainly allocates the expectable task ET expected to be repeatedly executed to the core 22, and does not allocate the normal task NT to the core 22, it is possible to prevent the problems such as preoccupancy and delay described above.

On the other hand, the scheduler 20 may also execute the task scheduling so that the core 23 mainly executes the normal task NT. In this way, when tasks are distributed to the cores 21, 22, 23 and 24 by simply considering the execution pattern, it is possible to improve the performance, while efficiently using the resources of the computing device 1, even without considering amounts of work of the cores 21, 22, 23 and 24, that is, the loads.

It is noteworthy that the core 22 is not fixed to execute only expectable tasks ET. That is, the scheduler 20 may designate the core which mainly executes expectable tasks ET, for example, as the core 23 depending on the operation situation of the computing device 1. That is, according to various embodiments of the present disclosure, the respective roles assigned to the cores 21, 22, 23 and 24 may dynamically change depending on the operating situation of the computing device 1.

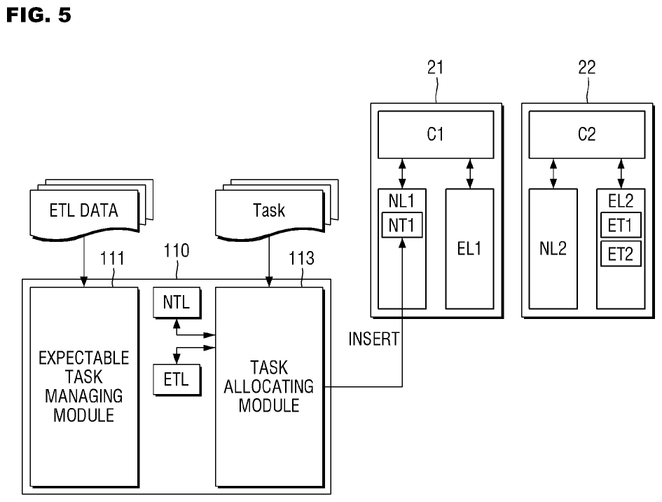

FIG. 7 is a block diagram for explaining the damage checking module in the task allocating and managing module of the computing device according to an embodiment of the present disclosure.

Referring to FIG. 7, the task allocating and managing module 110 of the computing device 1 according to an embodiment of the present disclosure may further include a damage checking module 115.

When the target core 22 is processing the expectable task ET or the expectable tasks ET1 and ET2 are inserted into the expectable task list queue EL2 of the target core 22, the damage checking module 115 may decide whether there is a risk of changing the order of the expectable tasks ET1 and ET2 by the normal task NT1, by comparing the expectable tasks ET1 and ET2 allocated to the target core 22 with the normal task NT1.

When it is decided by the damage checking module 115 that the risk is present(Risk exists), the task allocating module 113 may allocate the normal task NT1 to the normal task list NL1 of another core 21 other than the target core 22 of the multi-core processor 20, and if it is decided by the damage checking module 115 that the risk is not present (No Risk), it is possible to allocate the normal task NT1 to the normal task list NL2 of the target core 22.

For example, if the normal task NT1 is a task that may be executed for a very short time during the scheduled execution time of the expectable tasks ET1 and ET2, it may be decided that there is little risk of changing the execution schedule of the expectable tasks ET1 and ET2 by the normal task NT1. Also, if the normal task NT1 is a task with a lower priority than the expectable tasks ET1 and ET2, it may be decided that there is little risk of changing the execution schedule of the expectable tasks ET1 and ET2 by the normal task NT1.

In contrast, if the normal task NT1 is a task which is not executed during the scheduled execution time of the expectable tasks ET1 and ET2 or in which the execution time is very long even when executed during the scheduled execution time, it may be decided that there is high risk of changing the execution schedule of the expectable tasks ET1 and ET2 by the normal task NT1. In addition, if the normal task NT1 is a task having a higher priority than the expectable tasks ET1 and ET2, it may be decided that there is a high risk of changing the execution schedule of the expectable tasks ET1 and ET2 by the normal task NT1.

According to the present embodiment, it is possible to improve the performance, while avoiding or minimizing the problems such as preoccupancy and delay between the expectable tasks ET1 and ET2 and the normal task NT1, and while efficiently using resources of the computing device 1.

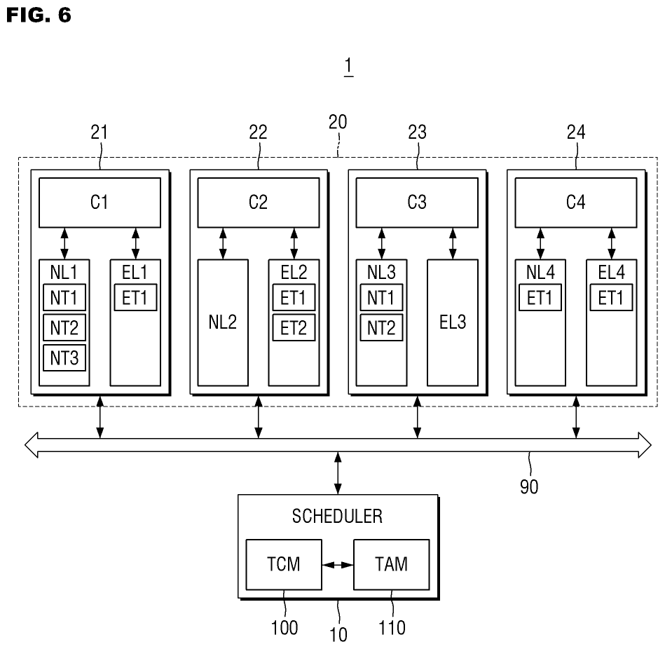

FIG. 8A and FIG. 8B are block diagrams illustrating a rebalancing module in the task allocating and managing module of the computing device according to an embodiment of the present disclosure.

Referring to FIG. 8A, the task allocating and managing module 110 of the computing device 1 according to an embodiment of the present disclosure may further include a rebalancing module 117.

When the expectable tasks ET1 and ET2 are inserted into the expectable task list queue EL2 of the target core 22 (see, e.g., FIG. 5), the rebalancing module 117 may move (MOVE) the expectable tasks ET1 and ET2 from the target core 22 to another core 21 other than the target core 22 of the multi-core processor 20.

After the expectable tasks ET1 and ET2 are moved to the other core 21 by the rebalancing module 117, the task allocating module 113 may allocate a normal task NT1 to the target core 22. That is, the task allocating module 113 may insert (INSERT) the normal task NT1 into the normal task queue NL2 of the target core 22.

For example, it may be necessary for the normal task NT1 to be executed on the target core 22 depending on the specific purpose in implementation. For example, when the target core 22 corresponds to a core that consumes more power than the other cores 21, 23 and 24 but has high performance, and the normal task NT1 corresponds to a heavy task (i.e., a task requiring high power and/or high performance) concerning, for example, a game application, the expectable tasks ET1 and ET2 may be moved to another core 21, and the normal task NT1 may be executed in the core 22.

According to the present embodiment, it is possible to improve the performance, while avoiding or minimizing the problems such as preoccupancy and delay between the expectable tasks ET1 and ET2 and the normal task NT1, and while fluidly using the computing device 1 depending on the purpose of use.

Referring to FIG. 8B, the task allocating module 113 of the computing device 1 checks whether an wake-up task is included in the expectable task list ETL. When the wake-up task is in the expectable task list ETL, the task allocating module 113 classifies the wake-up task to the expectable task ET1 and allocates the expectable task ET1 to the expectable task list EL1 of the core 21 which the expectable task ET1 is not disturbed by other task.

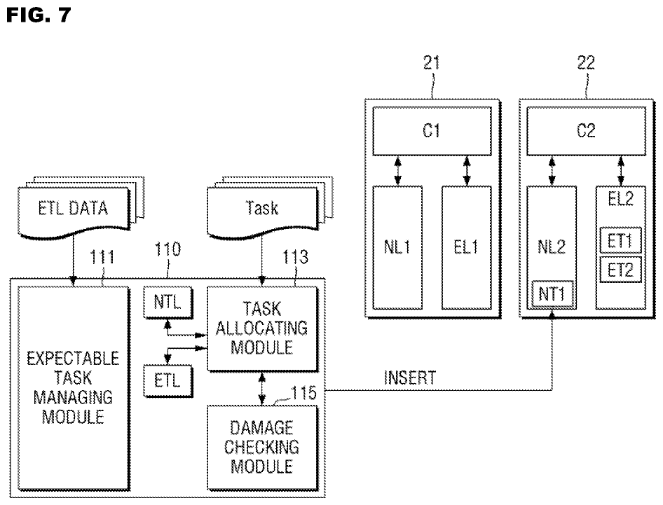

A method for operating the computing device 1 based on the structure of the computing device 1 described above will now be described with reference to FIGS. 9 to 14.

FIG. 9 is a flowchart for explaining the operation of the task classifying module of the computing device according to an embodiment of the present disclosure.

Referring to FIG. 9, the method for operating the task classifying module 100 of the computing device 1 according to an embodiment of the present disclosure may include collecting information (TASK INFO) on the task scheduled to be processed (S901), analyzing the collected information (TASK INFO) (S903), and deciding whether the task scheduled to be processed is an expectable task ET on the basis of the analysis result to classify the task scheduled to be processed into the expectable task ET and the normal task NT (S905).

Here, information (TASK INFO) on the task scheduled to be processed may include, for example, various kinds of information, such as task create information on an initial create operation of the task, task create time information, task enqueue information on the operation of allocating the task to a processor (or CPU (Central Processing Unit), core), task load update information on the operation of calculating the load of the task allocated to the processor (or CPU, core), task dequeue information on the operation of removing the allocated task from the processor (or CPU, core), task dead information on the termination and extinction operations of the task, and other user specified parameter information. However, embodiments are not limited thereto and, in some embodiments, the information may vary depending on the purpose of use implementation.

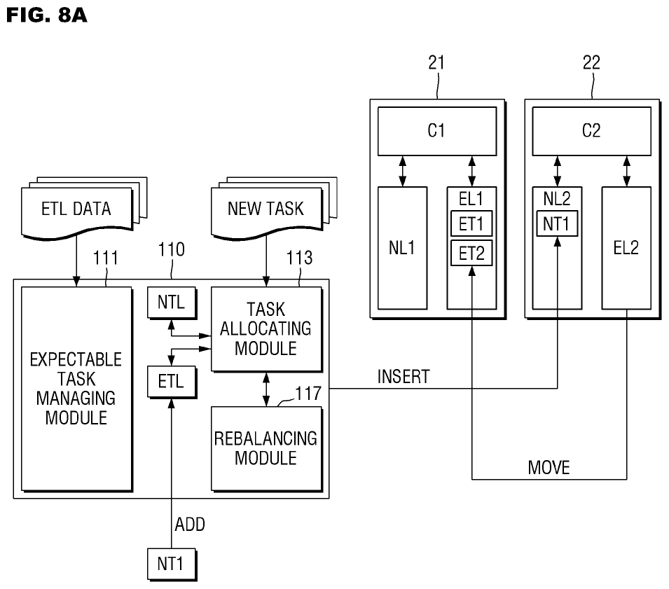

FIG. 10 is a flowchart illustrating the operation of the task classifying module of the computing device according to an embodiment of the present disclosure.

Referring to FIG. 10, the method for operating the task classifying module 100 of the computing device 1 according to an embodiment of the present disclosure may include collecting information on the task scheduled to be processed (TASK INFO) (S1001), analyzing the collected information (TASK INFO) to predict an execution time of the task scheduled to be processed (S1003), analyzing the collected information (TASK INFO) to predict a next start time of the task scheduled to be processed (S1004), and deciding whether the task scheduled to be processed is an expectable task ET on the basis of the prediction results to classify the task scheduled to be processed into the expectable task ET and the normal task NT (S1005).

That is, the task scheduled to be processed in which the execution time, the next start time, the number of times of repetition, and the like are decided to have an expectable execution pattern may be classified as the expectable task ET, and the task scheduled to be processed which is a one-time task or in which particular execution patterns are not found may be classified as the normal task NT.

In FIGS. 9 and 10, expectable task list data ETL may be generated as a result of classifying the task scheduled to be processed into the expectable task ET and the normal task NT, and the expectable task list data ETL may be used to manage the expectable task ET by the expectable task managing module 111 of the task allocating and managing module 110.

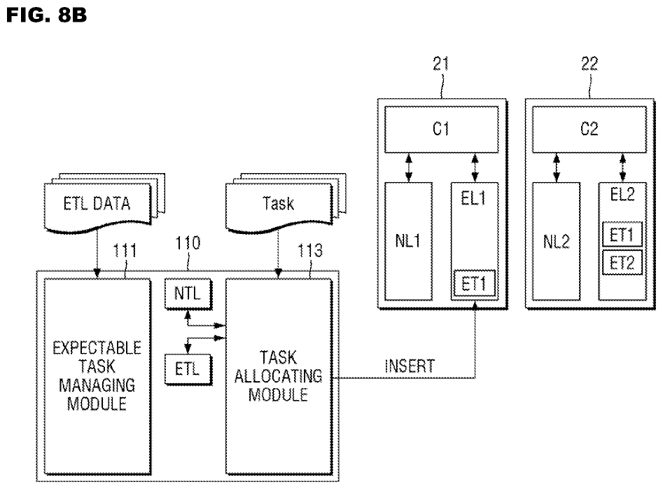

FIG. 11 is a flowchart for explaining the operation of the expectable task managing module in the task allocating and managing module of the computing device according to an embodiment of the present disclosure.

Referring to FIG. 11, the method for operating the task allocating and managing module 110 of the computing device 1 according to an embodiment of the present disclosure may include receiving a schedule information of task to process in the computing device 1 (S1101), checking the schedule information whether the task is a expectable task (S1103). When the task is expectable (S1103, Y), the task allocating and managing module 110 allocates the task into the expectable task list ETL (S1105). But when the task is not expectable (S1103, N), the task allocating and managing module 110 checks whether the task is in the expectable task list ETL (S1107). When the task is in the expectable task list ETL (S1107, Y), the task allocating and managing module 110 deletes the task from the expectable task list ETL (S1109). When the task is not in the expectable task list ETL (S1107, N), the process ends.

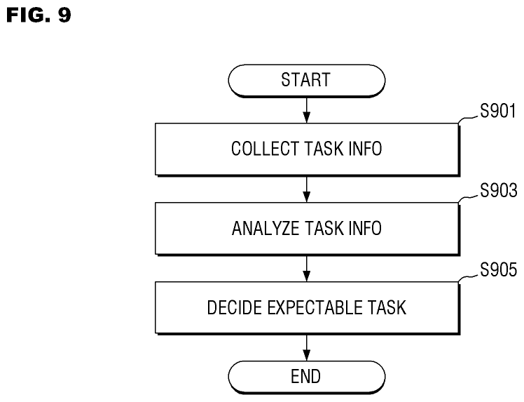

FIG. 12 is a flowchart for explaining the operation of the task allocating module in the task allocating and managing module of the computing device according to the embodiment of the present disclosure.

Referring to FIG. 12, the method for operating the task allocating module 113 in the task allocating and managing module 110 of the computing device 1 according to an embodiment of the present disclosure may include receiving a task (S1201), and selecting one core of the multi-core processor 20 as the target core 22 (S1203).

Since the task allocating module 113 designates the task as the normal task NT as a default when receiving the task, it is decided whether the target core has an expectable task ET in its expectable task queue EL (S1205). If the expectable task ET is inserted into the expectable task list queue EL2 of the target core 22 (S1205, Y), the task allocating module 113 selects another core of the multi-core processor 20 as the target core 21 (S1203).

Alternatively, if the expectable task ET is not inserted into the expectable task list queue EL2 of the target core 22 (S1205, N), a task is allocated to the normal task list queue NL2 of the target core 22 (S1207).

If the task is decided to be an expectable task, the task may be added to the expectable task list ETL (S1209).

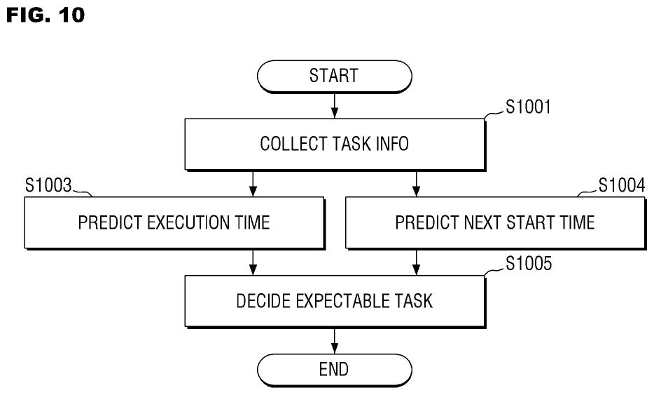

FIG. 13 is a flowchart for explaining the operation of the damage checking module in the task allocating and managing module of the computing device according to the embodiment of the present disclosure.

Referring to FIG. 13, the method for operating the task allocating module 113 in the task allocating and managing module 110 of the computing device 1 according to an embodiment of the present disclosure may include receiving a new task (S1303), and selecting one core of the multi-core processor 20 as the target core 22 (S1301).

Since the task allocating module 113 designates a new task as a normal task NT as a default when receiving the new task, it is determined whether the target core 22 has an expectable task ET in its expectable task list queue EL (S1305). If the expectable task ET is inserted into the expectable task list queue EL2 of the target core 22 (S1305, Y), it is decided whether there is a risk of damage (S1306). That is, it is determined whether there is a risk of changing the execution schedule of the expectable task ET by the new task.

If it is decided that there is a risk (S1306, Y), the task allocating module 113 selects another core of the multi-core processor 20 as the target core 21 (S1303).

Alternatively, if the expectable task ET is not inserted into the expectable task list queue EL2 of the target core 22 (S1305, N) or if the expectable task ET is inserted into the expectable task list queue EL2 of the target core 22 but it is decided that there is no risk (S1306, N), the new task is allocated to the normal task list queue NL2 of the target core 22 (S1307). If the task is decided to be an expectable task, the task allocating module 113 adds the new task to the expectable task list ETL (S1309).

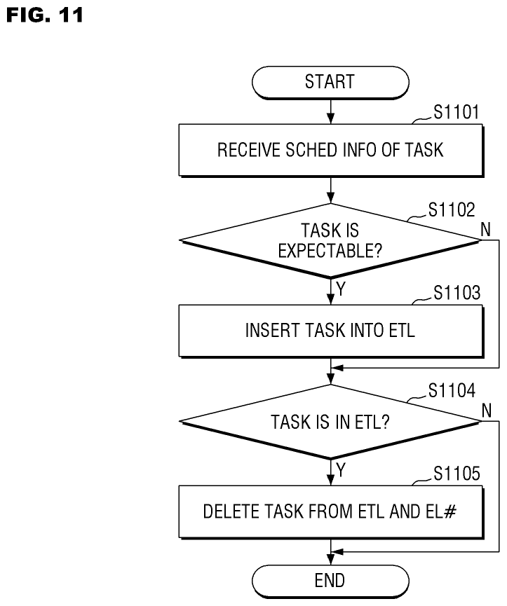

FIG. 14 is a flowchart for explaining the operation of the rebalancing module in the task allocating and managing module of the computing device according to the embodiment of the present disclosure.

Referring to FIG. 14, the method for operating the task allocating module 113 in the task allocating and managing module 110 of the computing device 1 according to an embodiment of the present disclosure may include receiving a task (S1401), and selecting one core of the multi-core processor 20 as the target core 22.

Since the task allocating module 113 designates a new task as a normal task NT as a default when receiving the new task, it is determined whether the target core 22 has an expectable task ET in its expectable task list queue EL (S1405). If the expectable task ET is inserted into the expectable task list queue EL2 of the target core 22 (S1405, Y), the expectable task ET is moved to the other core. Further, a new task is allocated to the normal task list queue NL2 of the target core 22 (S1407).

Alternatively, if the expectable task ET is not inserted into the expectable task list queue EL2 of the target core 22 (S1405, N), the new task is allocated to the normal task list queue NL2 of the target core 22 (S1407).

The aforementioned method may include analyzing the new task (S1409). As a result of the analysis, it is determined whether the new task is expectable (S1411). If the task is decided to be an expectable task, the task may be added to the expectable task list ETL (S1413).

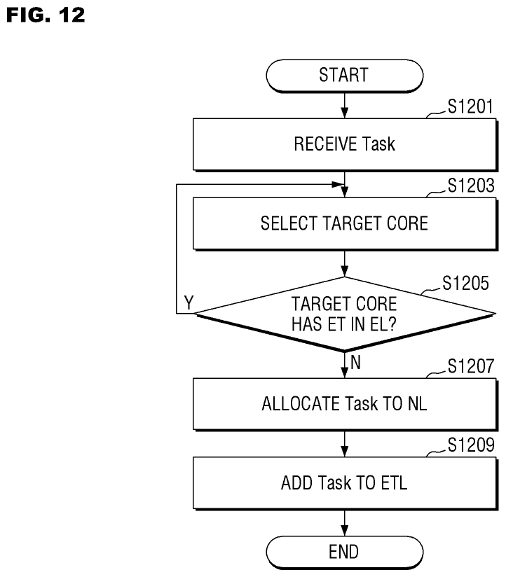

FIG. 15 is a block diagram illustrating the computing device according to an embodiment of the present disclosure.

Referring to FIG. 15, the computing device 2 according to an embodiment of the present disclosure may be implemented as a computing device that includes the scheduler 10 and the multi-core processor 20 according to various embodiments described above, and a memory 30, a storage 40 and a display 50. The scheduler 10, the multi-core processor 20, the memory 30, the storage 40 and the display 50 may exchange data with each other via the bus 90.

In some embodiments of the present disclosure, the computing device 2 may be implemented as a SoC (System-on-Chip), but the scope of the present disclosure is not limited thereto.

According to the various embodiments of the present disclosure explained above, in a situation in which the target core 22 processes the expectable tasks ET1 and ET2 which should be processed periodically, since the normal task NT is not newly allocated to the target core 22, it is possible to prevent problems such as preoccupancy and delay between the expectable tasks ET1 and ET2 and the normal task NT in advance. Furthermore, since the other cores 21 process the normal task NT in parallel, it is possible to improve the performance, while efficiently using the resources of the computing device 1.

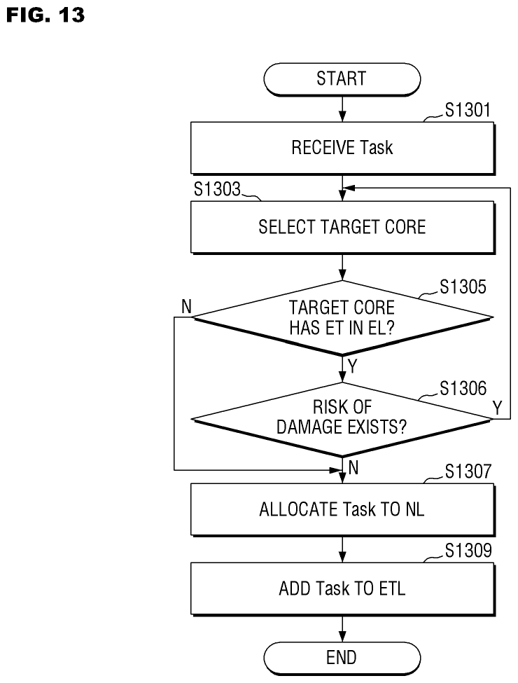

FIG. 16 is a flow chart illustrating the operation of the task allocating and managing module of the computing device according to an embodiment of the present disclosure.

Referring to FIG. 16, when the scheduler 10 receives a task scheduled to be processed, that is, a new task (S1601), the scheduler 10 analyzes task information on the new task (S1602). According to some embodiments, the task information may be information generated along with the task creation, including attributes, priority information, and the like of the task. In some embodiments, the task information may be information collected by the task information collecting module 101.

The scheduler 10 selects one of the plurality of cores depending on the task information (S1603).

The scheduler 10 checks whether there is a significant task in the selected core (S1604), and if there is no significant task (S1604, N), the scheduler 10 allocates a new task to the selected core (S1605). For example, the new task may be inserted into the selected core. The selected core schedules the processing order of the allocated new task on the basis of the task information.

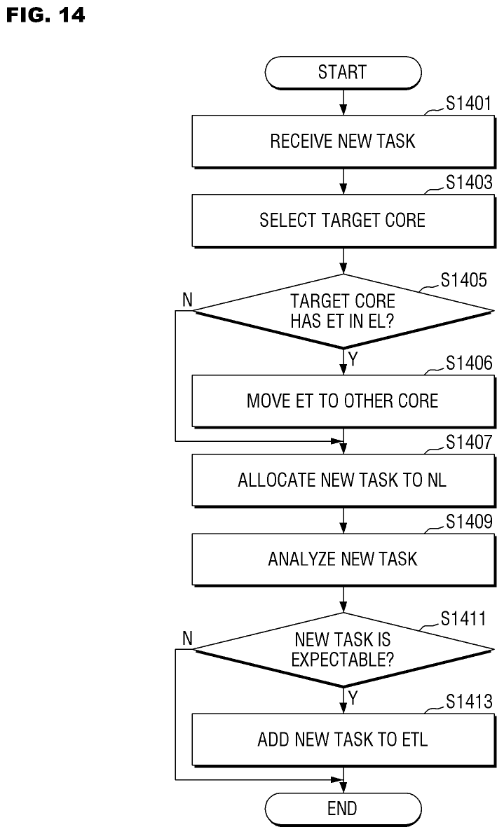

If there is a significant task in the selected core (S1604, Y), the scheduler 10 checks whether damage occurs in executing the previously allocated significant task when allocating the new task to the selected core (S1606). For example, the damage may be an interruption of an execution schedule of the significant task, a delay in the execution of the significant task, or other interference with the significant task, etc. If no damage occurs in the execution of the previously allocated significant task (S1606, N), a new task is allocated to the selected core (S1605). However, if damage occurs in processing the previously allocated significant task (S1606, Y), the selection of the corresponding core is not finalized, and another core among the plurality of cores is selected (S1603). The operation of the scheduler of FIG. 16 will be explained in detail on the basis of FIGS. 17 to 23.

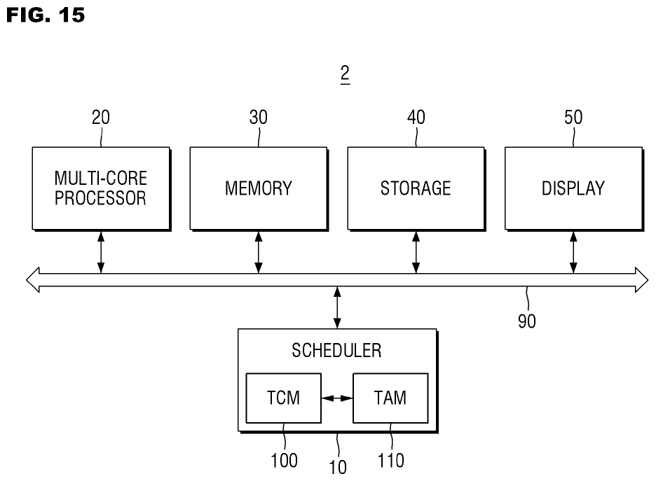

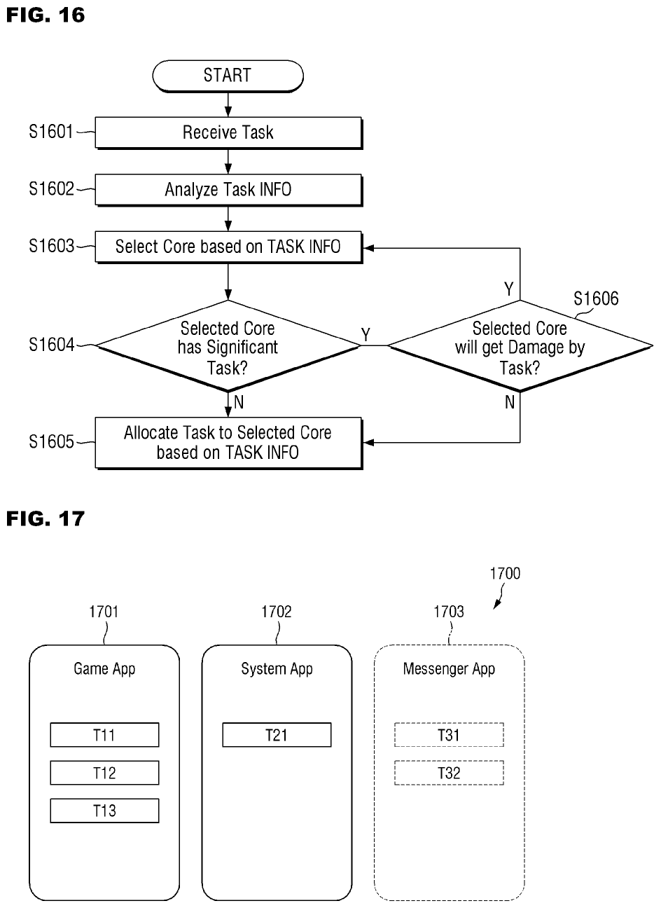

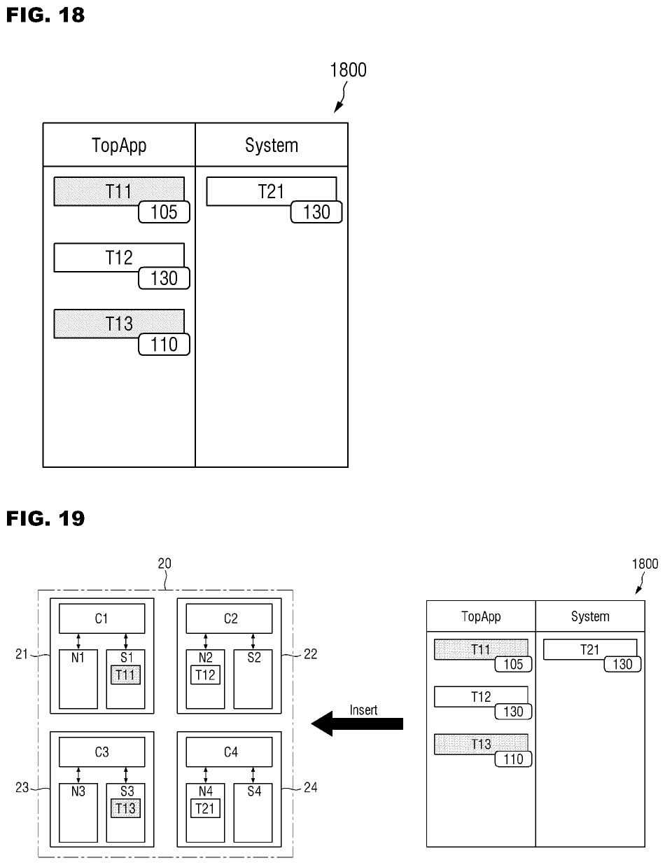

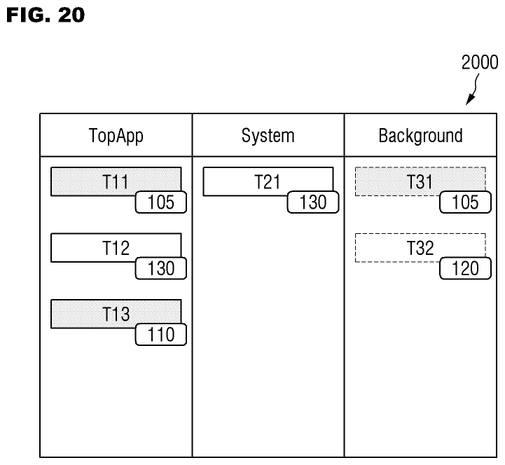

FIG. 17 is a block diagram illustrating task executed in the computing device according to an embodiment of the present disclosure. FIG. 18 is a block diagram illustrating the operation of the task classifying module according to the embodiment of FIG. 17. FIG. 19 is a block diagram illustrating the operation of the task allocating and managing module according to the embodiment of FIG. 17. FIG. 20 is a block diagram illustrating the operation of the task classifying module according to the embodiment of FIG. 17. FIGS. 21 to 23 are block diagrams illustrating the operation of the task allocating and managing module according to the embodiment of FIG. 17.

The computing device 1 may constantly process and generate the plurality of tasks. FIG. 17 shows tasks currently being processed or already allocated and task scheduled to be processed in the computing device 10. The tasks currently being processed or allocated are indicated by solid lines 1701 and 1702, and tasks scheduled to be processed as new tasks is indicated by a dashed line 1703.

Assume that a game application 1701 and a system application 1702 are currently executing on the computing device 1. Assume that the game application 1701 is executing tasks T11, T12, and T13 for multi-media processing, and the system application 1702 is executing task T21, for example, for clock display, battery display, and the like.

Referring to FIGS. 17, 18 and 19, the scheduler 10 analyzes the task information of the tasks T11, T12, T13 and T21. According to some embodiments, the task information may include task attributes and priority information. The task attributes may mean, for example, Load, Util, Cgroup, Priority, Task Class in the case of Linux. Among the task attributes, in the case of CGROUP, the task attributes may include sub-attributes such as ROOT, FOREGROUND, BACKGROUND, TOPAP, RT, SYSTEM, SYSTEMBACKGROUND, NNAPI_HAI, CAMERA_DAEMON, and COUNT.

As an example, a user of the computing device may change a current application execution at any time. In this case, the scheduler 10 may analyze TOPAPP among the CGROUP attributes of the task information to check a top application among the plurality of applications currently being executed by the user. For example, the top application may be an application currently executing in a foreground.

In the above example, assuming that the user is currently executing a game application and playing a game, the scheduler 10 sets the game application as the top application, and apart from this setting, sets the system necessary for the basic operation of the device as a subordinated application.

The scheduler 10 checks priority information for tasks belonging to each application. In some embodiments, the computing system 1 may, for example, divide tasks into priority values from 0 to 139 and refer to the priority values at the time of task processing. In some embodiments, the scheduler 10 may divide the tasks into the priority values and refer to the priority values in task processing. According to some embodiments, the priority values may have higher priority as the priority values become lower. That is, the lower the priority value the higher the priority of the task. For example, a task with a priority value of 0 would have a higher priority than a task with a priority value of 5.

In the example illustrated in FIG. 18, task T11 has a priority value of 105, T12 has a priority value of 130, T13 has a priority value of 110, and T21 has a priority value of 130. Since the task T11 has a lower priority value than the task T12, the task T11 has a higher priority that task T12.

The scheduler 10 sets a reference value, determines a task having a priority value equal to or less than the set reference value as an significant task (or patterned task), and when the determined significant task is allocated, the scheduler 10 prevents execution of the significant task from being disturbed by other tasks. Assuming that the reference value is 110 in the illustrated example, the scheduler 10 determines tasks T11 and T13 as significant tasks and tasks T12 and T21 as normal tasks.

In the example illustrated in FIG. 19, since there are four cores included in the processor 20 between the top application (TopApp) and the subordinated application execution 1800, tasks T11, T12, T13 and T21 may be allocated to respective cores C1, C2, C3 and C4. The cores C1, C2, C3, and C4 of the processor 20 respectively include significant task list queues S1, S2, S3, and S4 and normal task list queues N1, N2, N3, and N4. The cores C1, C2, C3, and C4 put allocated tasks into respective list queues depending on whether the allocated tasks are significant tasks or normal tasks. For convenience of explanation, although the case where one task is allocated to one core has been described, when the plurality of normal tasks have already been allocated to one normal list queue according to some embodiments, the scheduler may adjust the execution order of tasks on the basis of priority values.

As illustrated in FIG. 17, when a user receives a message (for example, an SNS message) while executing the game application 1701 and the system application 1702, and the user newly executes the messenger application 1703, the messenger application may generate T31 and T32 as new tasks.

Referring to FIG. 20, the scheduler 10 analyzes the messenger application 1703 and attributes and task information of the tasks T31 and T32 generated by the messenger application 1703. In the example illustrated in FIG. 20, the scheduler 10 determines that the messenger application 1703 is a background application when the user does not execute the messenger application at the top level, the task T31 has a priority value of 105, and the task T32 has a priority value of 120. Depending on a result of comparing the priority value with the reference value, the task T31 is determined as a significant task, and the task T32 is determined as a normal task. The scheduler 10 allocates the tasks T31 and T32 to the multi-cores of the processor 20 according to the priority values.

A case where the scheduler 10 selects the core C1 and allocates the task T31 will be described with reference to FIGS. 21 and 22. The scheduler 10 checks whether the task T31 may be allocated to the significant task list queue S1 belonging to the core C1. Specifically, the scheduler 10 checks whether there is a significant task remaining unexecuted in the significant task list queue S1 of the core C1.

Referring to FIG. 21, the core C1 is in a state of having a significant task T11 in the significant task list queue S1. The scheduler 10 checks whether damage occurs when executing the already allocated task T11, if the task T31 is allocated to the significant task list queue S1. Damage means, for example, whether T31 should be executed before task T11 is completed. Whether damage occurs may be checked based on the attributes and task information of the task T31 and the execution schedule of task T11. If no damage occurs in executing the task T11 and then the task T31 may be executed, the scheduler 10 allocates the task T31 to the significant task list queue S1. In other words, if no damage occurs in executing the task T11 if the task T31 is allocated to the core C1, the scheduler 10 allocates the task 31 to the significant task list S1.

Referring to FIG. 22, the scheduler 10 may not allocate the task T31 to the core C1, if it is expected that damage occurs in the execution of the previously allocated task T11, when the task T31 is allocated to the significant task list S1.

If the scheduler 10 determines that damage will occur if the task T31 is allocated to core C1, the scheduler 10 selects core C2, which is one of the other cores, and checks whether task T31 can be allocated to the significant task list queue S2. Since there is no currently allocated significant task in the significant task list queue S2 of the core C2, the scheduler 10 allocates the task T31 to the core C2. At this time, the core C2 puts the allocated task T31 into the significant task list queue S2.

A case where the scheduler 10 selects a core C4 and allocates a task T32 will be described with reference to FIG. 23. Since the task T32 is a normal task, the task T32 may be allocated and inserted into any one of the normal task lists N1, N2, N3, and N4 of the cores C1, C2, C3, and C4. For example, the scheduler 10 may allocate the task T32 to the core C4, to which a significant task is not allocated currently. In other words, since the significant task list queues S1, S2, and S3 of cores C1, C2, and C3 each have a significant task previously allocated, the scheduler 10 may allocate the task T32 to the core C4, to which a significant task is not allocated currently.

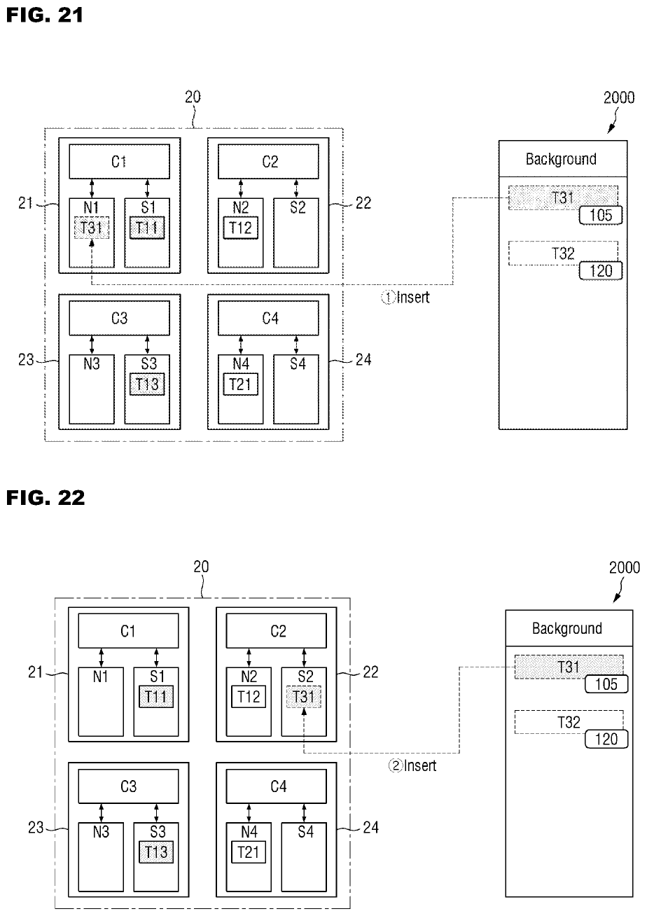

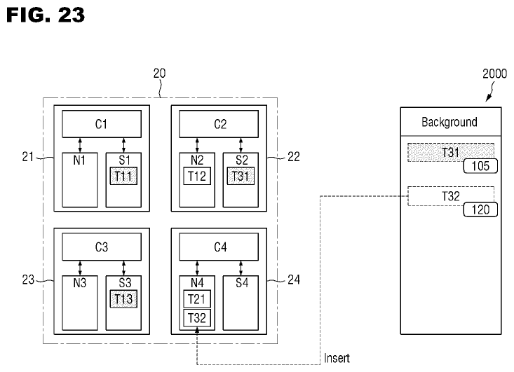

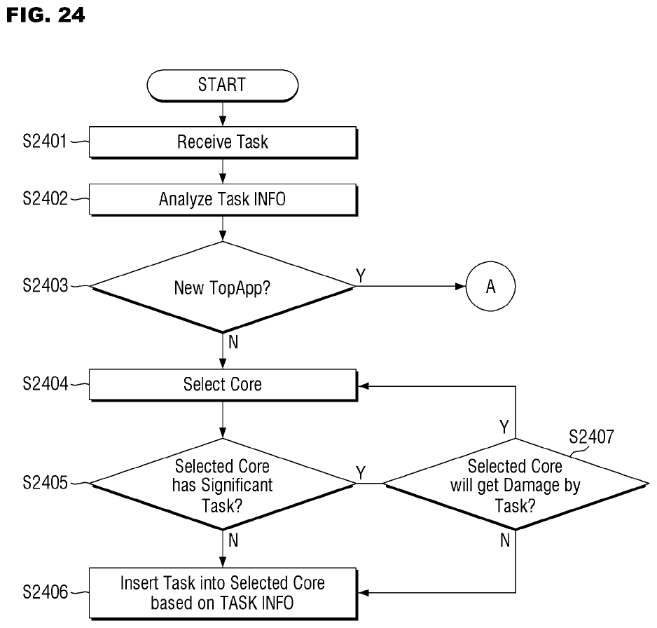

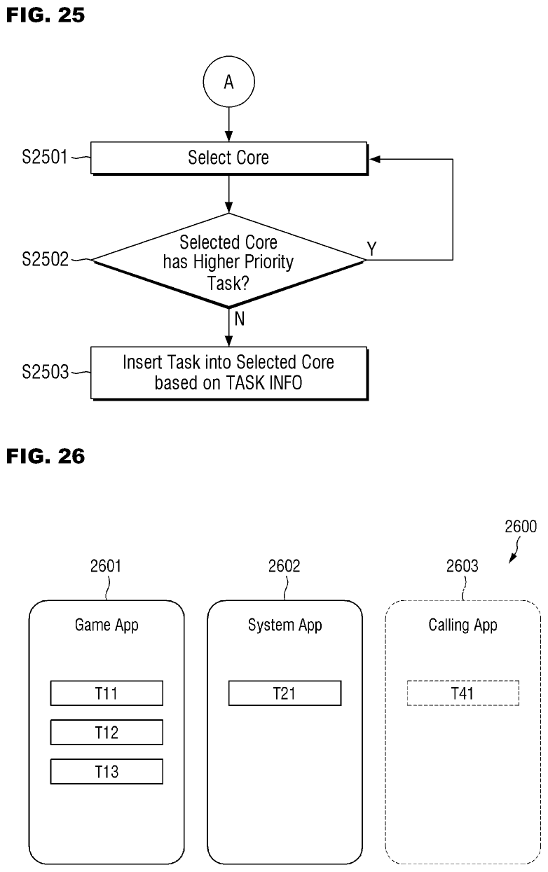

FIGS. 24 and 25 are flow charts illustrating the operation of the task allocating and managing module of the computing device according to some embodiments. FIG. 26 is a block diagram illustrating tasks executed in the computing device according to some embodiments. FIG. 27 is a block diagram illustrating the operation of the task classifying module according to the embodiment of FIG. 26. FIG. 28 is a block diagram illustrating the operation of the task allocating and managing module according to the embodiment of FIG. 26.

Referring to FIGS. 24 and 25, when the scheduler 10 receives a new task (S2401), the scheduler 10 analyzes the task information TASK INFO of the new task (S2402). According to some embodiments, the task information may be information generated along with the task creation, including attributes, priority information, and the like of the task. In some embodiments, the task information may be information collected by the task information collecting module 101.

The scheduler 10 executes steps S2404 to S2407 as explained in FIG. 16 (S1603, S1604, S1605, and S1606) on the basis of the task information, if the attributes of the application to which the new task belongs are not the top application (TopApp) (S2403, N). Since steps S2404 to S2407 correspond to steps S1603-S1606, repeated description thereof is omitted for conciseness. However, if the attributes of the application to which the new task belongs are the top application (TopApp) (S2403, Y), the scheduler executes the steps as shown in FIG. 25.

Referring to FIG. 25, the scheduler 10 selects one core among a plurality of cores (S2501) and checks whether there is a task with a high priority in the significant task list queue and the normal task list queue belonging to the selected core (S2502).

If there is a task with higher priority than the new task in the significant task list queue or the normal task list queue belonging to the selected core, that is, if an existing task with higher priority is allocated (S2502, Y), the scheduler 10 selects another core (S2501).

If there is a task with a lower priority than the new task in the significant task list queue or the normal task list queue belonging to the selected core, that is, if an existing task with a lower priority is allocated (S2502, N), the scheduler 10 allocates the new task to the selected core (S2503). The new task is allocated by inserting the new task into the significant task list queue or the normal task list queue depending on the attributes (e.g., priority value) of the new task.

The operation of the scheduler of FIGS. 24 and 25 will be described in detail on the basis of FIGS. 26 to 28.

Referring to FIG. 26, assume that a game application 1701 and a system application 1702 are currently executing on the computing device 1. Assume that the game application 1701 is executing tasks T11, T12, and T13 for multi-media processing, and the system application 1702 is executing task T21, for example, for clock display, battery display, and the like.

When the user is called while a game application 2601 and a system application 2602 are executing and a call application 2603 is newly executed by the user, the call application 2603 may generate task T41 as a new task. When the user receives a call, the scheduler 10 analyzes task attributes of the task T41 and allocates the task to one of the plurality of cores.

Referring to FIG. 27, the scheduler 10 analyzes the call application 2603 and task attributes of the task T41 (2700). The task T41 is checked by the top application (CGROUP_TopApp) according to the execution of the call application 2603 by the user. The scheduler 10 checks priority information of the task T41 and determines that task T41 has a priority value of 92. Since priority value 92 is smaller than the reference value 110, the scheduler 10 determines the task T41 is a significant task.

Referring to FIG. 28, the scheduler 10 checks the significant task list queues S1-S4 and the normal task list queues N1-N4 of the cores C1-C4 and selects one core of a plurality of cores CT-C4 and allocates the task T41 having the top application attributes to the selected core. For example, in the case of cores C1 and C3, the cores C1 and C3 includes significant tasks T11 and T13 already allocated to significant task list queues S1 and S3, respectively. In this case, the task T41 has a higher priority than the task T11 or T13 and can therefore be allocated to core C1 or C3.

However, since there are also cores C2 and C4 that have only normal tasks previously allocated, the scheduler 10 may initially select core C2 or C4, to which only the normal task is allocated so that the execution of previously allocated significant tasks is not disturbed. For example, if the task T41 is allocated to the core C2, since the task T41 can be executed before the normal task T12 that is previously allocated to the core C2, the task T41 is inserted into the significant task list queue S2.

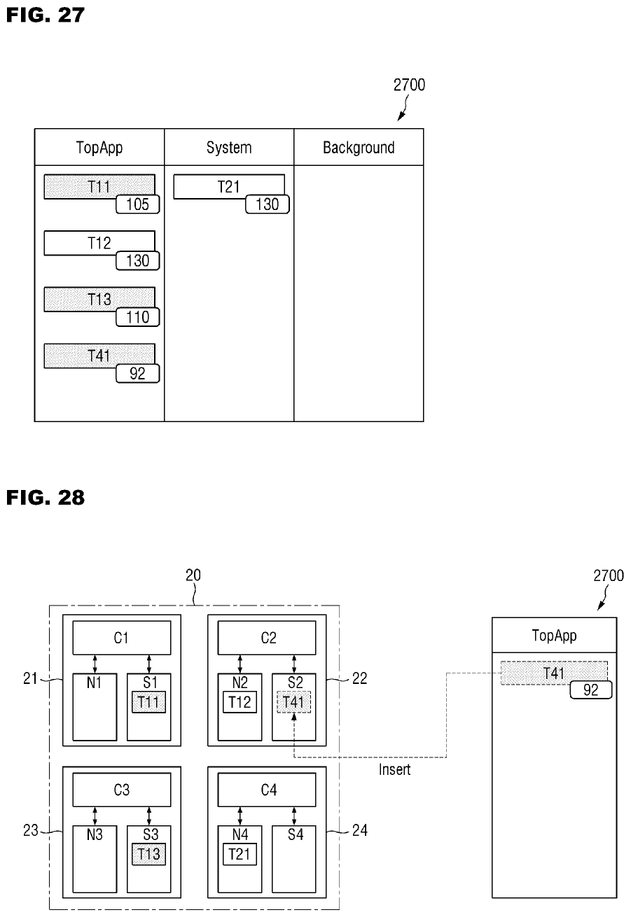

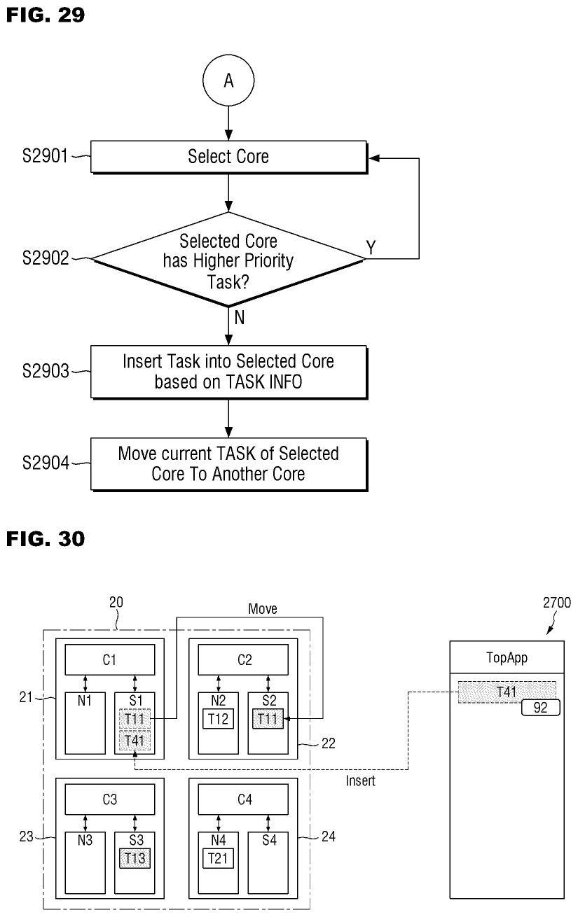

FIG. 29 is a flow chart illustrating the operation of the task allocating and managing module of the computing device according to some embodiments. FIG. 30 is a block diagram illustrating the operation of the task allocating and managing module according to the embodiment of FIG. 29.

Referring to FIGS. 24 and 29, the scheduler 10 selects one core of the plurality of cores (S2901) and checks whether there is a task with a high priority in the task list belonging to the selected core (S2902).

If there is a task with a higher priority than the new task in the significant task list queue or the normal task list queue belonging to the selected core, that is, if an existing task with higher priority is allocated (S2902, Y), the scheduler 10 selects another core (S2901).

If there is a task with a lower priority than the new task in the significant task list queue or the normal task list queue belonging to the selected core, that is, if an existing task with a lower priority is allocated (S2902, N), the scheduler 10 allocates a new task to the selected core (S2903). The new task is inserted into the significant task list queue or the normal task list queue depending on the attributes (e.g., priority value) of the new task.

In some embodiments, after allocating the new task T41 to the selected core, the scheduler 10 may move an already allocated task that has already been allocated to the selected core to another core (S2904). For example, specific tasks may necessarily need to be executed on a designated core depending on the specific implementation purposes. The described embodiments may be scheduled to execute on designated cores, when corresponding to calling applications or heavier tasks than existing applications to be executed.

Referring to FIG. 30, when a new task (NEW TASK) T41 is input, the scheduler 10 may allocate the new task T41 to core C1 and may move task T11 already allocated to the core C1 to another core C2. This operation allows the computing device to more easily execute the new application and the task T41 thereof. FIGS. 29-30 describe that the new task is allocated first and then the existing task is moved to another core. However, embodiments are not limited thereto and, in some embodiments, the step S2904 may be executed before step S2903. In other words, when a new task (NEW TASK) T41 is input, the scheduler 10 may first move task T11 already allocated to the core C1 to another core C2 and then allocate the new task T41 to the core C1.

Those skilled in the art will appreciate that many variations and modifications may be made to the embodiments disclosed herein without substantially departing from the principles of the present disclosure. Therefore, the disclosed embodiments of the disclosure are used in a generic and descriptive sense only and not for purposes of limitation.

What is claimed is:

1. A computing device comprising:
a multi-core processor which includes at least two cores, each having a significant task list queue and a normal task list queue; and
a scheduler which allocates a task to each of the at least two cores,
wherein the scheduler is configured to:
following allocation of the tasks, receive a new task,
select one core among the at least two cores based on task information of the new task, and
allocate the new task to the selected core, when the allocation of the new task to the selected core will not change an execution schedule of a significant task in the significant task list queue of the selected core.

2. The computing device of claim 1, wherein the task information comprises task attributes and priority values.

3. The computing device of claim 2, wherein the task attributes comprise attributes indicating whether there is a top application to which the new task belongs.

4. The computing device of claim 2, wherein the scheduler compares a priority value of the priority values with a reference value,
when the priority value of the new task is less than the reference value, the scheduler inserts the new task into the significant task list queue, and
when the priority value of the new task is greater than or equal to the reference value, the scheduler inserts the new task into the normal task list queue.

5. The computing device of claim 4, wherein when the scheduler inserts the new task into the normal task list queue, the scheduler adjusts an execution order of the new task in the normal task list queue based on the priority value.

6. The computing device of claim 1, wherein the significant task is a task whose execution is not disturbed by another task.

7. The computing device of claim 1, wherein the task information comprises:
task create information on an initial create operation of the task, task create time information, task enqueue information, task load update information, task dequeue information, task dead information, and user specified parameter information,
wherein the scheduler determines whether the new task is a significant task, based on the task information, and
wherein the significant task is performed with a certain execution pattern.

8. The computing device of claim 3, wherein, when the new task belongs to the top application, the scheduler checks the significant task list queue and the normal task list queue of each of the at least two cores,
the scheduler selects, as the one core, a core having only tasks with lower priority among tasks previously allocated to the at least two cores, based on the significant task list queues and the normal task list queues.

9. The computing device of claim 3, wherein, when the new task belongs to the top application, the scheduler moves the task previously allocated to the one core of the at least two cores to a second core of the at least two cores, and
the new task is allocated to the one core.

10. A computing device comprising:
a multi-core processor which includes a first core and a second core; and
a task allocating and managing module configured to:
check task information of a new task to determine whether the new task disturbs an execution of at least one of previous significant tasks in the second core, and
allocate the new task to the first core when the new task disturbs the execution of the at least one of previous significant tasks in the second core.

11. The computing device of claim 10, wherein the task information comprises task attributes and priority values.

12. The computing device of claim 10, wherein the at least one of previous significant tasks are tasks whose execution is not interrupted by another task.

13. The computing device of claim 11, wherein the task attributes comprise a plurality of sub-attributes, including a top application attribute, and
when a task attribute of the new task has the top application attribute, the task allocating and managing module is configured to:
check task list queues of the first core and the second core,
select the first core that has only tasks with lower priority among previously allocated tasks in the task list queues, and
allocate the new task to the selected the first core.

14. The computing device of claim 11, wherein the task attributes comprise a plurality of sub-attributes, including a top application attribute, and
when a task attribute of the new task has the top application attribute, the task allocating and managing module is configured to:
move a task that is previously allocated to the first core, to the second core, and
allocate the new task to the first core.

15. A method for operating a computing device, the method comprising:
receiving a new task by the computing device which includes a multi-core processor including a plurality of cores;
classifying the new task into a user driven task and a normal task based on task information including task attributes and priority values of the new task; and
allocating the new task to one core among the plurality of cores depending on a classifying result.

16. The method of claim 15, wherein the classifying comprises:
classifying the new task as the user driven task when the task attributes of the new task include top application attributes and the priority values of the new task include a priority value that is smaller than a reference value.

17. The method of claim 16, wherein, when the new task is classified as the user driven task, the allocating comprises:
selecting a core among the plurality of cores that has only previously allocated tasks with a lower priority than a priority of the new task based on the priority value of the new task, and
allocating the new task to the selected core.

18. The method of claim 16, wherein, when the new task is classified as the user driven task, a task previously allocated to a first core among the plurality of cores is moved to a second core of the plurality of cores, and
the new task is allocated to the first core.

19. A computing device comprising:
a multi-core processor which includes a plurality of cores; and
a scheduler configured to:
receive a new task;
select a first core of the plurality of cores;
allocate the new task to the first core when task information of the new task indicates that allocating the new task to the first core will not change the execution schedule of a task previously allocated to the first core;
when the task information of the new task indicates that allocating the new task to the first core will change the execution schedule of the task previously allocated to the first core, select a second core of the plurality of cores other than the first core, and allocate the new task to the second core based on the task information of the new task and an execution schedule of a task previously allocated to the second core.

20. The computing device of claim 19, wherein the scheduler is configured to compare the task information of the new task with the execution schedule of the task previously allocated to the first core to determine whether allocating the new task to the first core will change the execution schedule of the task previously allocated to the first core.

21. The computing device of claim 19, wherein the scheduler is configured to compare execution attributes included in the task information of the new task with the execution schedule of the task previously allocated to the first core to determine whether allocating the new task to the first core will change the execution schedule of the first core.
